(19) United States
(12) Patent Application Publication
(10) Pub. No.: US 2026/0095481 A1
(43) Pub. Date: Apr. 2, 2026

(54) LEVERAGING QUANTUM COMPUTING ARTIFICIAL INTELLIGENCE TO PREVENT CYBERATTACKS ON QUANTUM IOT DEVICES

(71) Applicant: Bank of America Corporation, Charlotte, NC (US)

(72) Inventors: Swagata Banerjee, Thane West Maharastra (IN); Manu Kurian, Dallas, TX (US)

(21) Appl. No.: 18/901,117

(22) Filed: Sep. 30, 2024

(51) Int. Cl. H04L 9/40; H04L 9/08

(52) U.S. Cl. CPC H04L 63/1491; H04L 9/0819; H04L 9/0852

(57) ABSTRACT

Systems and methods may prevent or mitigate the possibility of cyberattacks on a heterogeneous network of quantum IoT devices that use AI. An AI algorithm on a device may be trained on data obtained during interaction with third party computer applications or systems. An aggregator may compile and aggregate the data used to train the local AI algorithms operating separately at each of the quantum IoT devices for use in a network-wide AI algorithm. Quantum key distribution may be used to control which of the quantum IoT devices controls security rules to be used in the IoT network. The security rules may be based on the aggregated data and may determine whether or to what extent a quantum IoT device may use the IoT devices to interact with third party applications or systems outside of the network.

### FIELD OF THE DISCLOSURE

Aspects of the disclosure relate to using quantum key distribution and aggregation of quantum computing artificial intelligence (AI) from multiple Internet of Things (IoT) devices to prevent or mitigate cyberattacks on quantum IoT devices.

### BACKGROUND OF THE DISCLOSURE

Quantum IoT devices are IoT devices that have quantum processors. A heterogeneous network of IoT devices is a network of IoT devices where different IoT devices may use different technologies and protocols, such as different operating systems or processors. A heterogeneous network may include quantum IoT devices only or a mix of quantum IoT devices and classical IoT devices that use classical processors.

Quantum IoT devices may exchange data with each other, such as over the Internet. Quantum IoT devices may be used to access and interact with third-party applications or systems that possess confidential or sensitive information or with which a user may perform transactions. For example, quantum IoT devices may be used to perform online banking. Like other electronic devices, quantum IoT devices may be subject to cyberattacks. IoT devices may not have the same level of security features that are currently available for computers or other electronic devices, such as tablets or mobile phones.

There is a need for a solution to prevent or mitigate the risk of cyberattacks on quantum IoT devices to safeguard confidential or sensitive information from malicious activity and unauthorized access.

It would be desirable to provide a system and method that enables at least some of the IoT devices in a heterogeneous network of quantum IoT devices to leverage AI or quantum keys, or a combination of both to enhance security of communications by the IoT devices with third-party applications or systems to prevent or mitigate the possibility of cyberattacks on the IoT devices.

### SUMMARY OF THE DISCLOSURE

It is an object of this invention to provide a system and method that may be used to prevent or mitigate cyberattacks on quantum IoT devices.

A system in accordance with the present disclosure may include a network that includes a plurality of quantum IoT devices. Each of the plurality of quantum IoT devices may include a respective quantum processor. Each of the plurality of quantum IoT devices may include a quantum key distribution application that is configured to distribute a quantum key to one or more of the plurality of quantum IoT devices. The quantum key distribution application may include an AI algorithm that is configured to enable each of the plurality of quantum IoT devices to select one or more of the plurality of quantum IoT devices to which to distribute one or more copies of the quantum key. Receipt of one of the one or more copies of the quantum key by a respective one of the plurality of quantum IoT devices may enable the respective quantum IoT device to participate in determining security rules for managing interactions or transactions between the plurality of quantum IoT devices and a third-party computer application or system. The security rules may mitigate cyberattacks on the plurality of quantum IoT devices.

The plurality of quantum IoT devices may include heterogeneous quantum IoT devices that use different operating systems or protocols. The AI algorithm may be configured to generate a consensus among the plurality of quantum IoT devices that receive one of the one or more copies of the quantum key as to which of the plurality of quantum IoT devices controls future distribution of the quantum key. The AI algorithm may be configured to generate the consensus using a game-based algorithm. The AI algorithm may be trained based on previous decisions made by the plurality of quantum IoT devices.

The security rules may be configured to be dependent on a monetary size of a transaction to be conducted by one of the plurality of quantum IoT devices. The AI algorithm may require a predetermined quorum of the plurality of quantum IoT devices to agree to the security rules. The AI algorithm may be configured to optimize resource distribution for the plurality of quantum IoT devices.

The quantum key distribution application may be configured to require completion of a form by each quantum IoT device to participate in a determination of the security rules. The AI algorithm may be configured to provide to the quantum IoT device at which an attempted fraud is detected a decoy form upon detection by the AI algorithm of the attempted fraud by one of the plurality of quantum IoT devices. Execution of the decoy form may not allow access to the quantum key by the quantum IoT device at which the attempted fraud is detected. The AI algorithm may include a generative AI algorithm that is configured to generate the decoy form in real time.

The network may include a fraud alert system that is configured to propagate a fraud alert message from one of the plurality of quantum IoT devices that has detected fraud or attempted fraud to others of the plurality of quantum IoT devices in the network. The network may include an aggregator for aggregating data collected from the plurality of quantum IoT devices.

The third-party computer application or system may include a banking network accessed by one or more of the plurality of quantum IoT devices.

The plurality of quantum IoT devices may include a classical IoT device comprising a classical processor.

A system in accordance with the present disclosure may include a network that that includes a plurality of quantum IoT devices. Each of two or more of the plurality of quantum IoT devices may include a quantum processor, an application that is operable, using the quantum processor, to provide electronic access from a respective one of the plurality of quantum IoT devices to one or more third-party computer applications or systems operated by a third party, and a first artificial intelligence (AI) algorithm that is trained, using the quantum processor, based on data derived from user interactions between the respective quantum IoT device and the one or more third-party computer applications or systems. The system may include an aggregator, that includes a processor. The aggregator may be operable to aggregate data derived from the user interactions with the one or more third-party computer applications or systems and the plurality of quantum IoT devices. The aggregator may be operable to provide the aggregated data to a second AI algorithm at the one or more computer applications or systems in the network to be used to train the second AI algorithm to prevent or mitigate cyberattacks on the plurality of quantum IoT devices. The third party may be a financial institution.

The aggregator may be configured to anonymize the aggregated data so that the aggregated data does not identify a user of a respective one of the plurality of quantum IoT devices from which the aggregated data has been obtained. The aggregator may be configured to train one or more ML models of the second AI algorithm.

The system may include a quantum key distribution application that is configured to operate across the plurality of quantum IoT devices. The quantum key distribution application may include a third AI algorithm that is configured to select one or more of the plurality of quantum IoT devices to which to distribute a copy of a quantum key across the plurality of quantum IoT devices. Possession of the quantum key by a respective one of the plurality of quantum IoT devices may enable the respective ones of the plurality of quantum IoT devices to which the copies of the quantum key are distributed to determine security rules for managing interactions between the plurality of quantum IoT devices and a respective third-party computer application or system or a third-party network to prevent or mitigate the cyberattacks on the plurality of quantum IoT devices.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system architecture in accordance with principles of the disclosure.

FIG. 2 shows an illustrative apparatus of a device in accordance with principles of the disclosure.

FIG. 3 shows an illustrative system architecture in accordance with principles of the disclosure.

FIG. 4 shows an illustrative quantum IoT device in accordance with principles of the disclosure.

FIG. 5 shows an illustrative quantum computer that may interact with the quantum IoT devices in accordance with principles of the disclosure.

FIGS. 6A and 6B show illustrative diagrams in accordance with the principles of the disclosure.

FIG. 7 shows an illustrative flow chart for preventing or mitigating cyberattacks on quantum IoT devices that use AI in accordance with the principles of the disclosure.

### DETAILED DESCRIPTION OF THE DISCLOSURE

Methods, systems, and apparatus may be provided for mitigating the possibility of cyberattacks on a heterogeneous network of quantum IoT devices. Data stored on the quantum IoT devices may be stored in the form of quantum bits (“qubits”). The quantum bits may be stored as quantum-entangled particles.

The quantum IoT devices in the heterogeneous network may each include a quantum processor. The quantum IoT devices methods, systems, and apparatus may employ a quantum key distribution application. Quantum key distribution enables secure communications by generating a shared secret key that recipients may use to encrypt and decrypt messages. The quantum key distribution application may operate as an application operating on the network or in communication with the network.

The possession of a quantum key by a quantum IoT device may assist with algorithms that are performed using IoT devices. For example, the receiving quantum IoT device may use the quantum key to participate in governance decisions for the network of IoT devices by enabling communications between the quantum IoT devices in the network to determine security rules for the network for managing engagement between the quantum IoT devices and a third-party application or system (e.g., a third party network) to prevent or mitigate cyberattacks on the quantum IoT devices. The engagement may include interactions between the quantum IoT devices and the third-party application or system. Security rules may be adopted by a consortium of the quantum IoT devices when a consensus (agreement) of the quantum IoT devices about the security rules is obtained. The quantum key may be sent to all the quantum IoT devices in the network or may be sent to only a subset of the quantum IoT devices in the network.

The IoT network may have governing rules that specify that a consensus on the selection of security rules is achieved by a majority vote by the devices. The governing rules may specify that the consensus requires unanimity.

Security rules for the IoT network may be selected to prevent or mitigate cyberattacks on the quantum IoT devices. One or more of the quantum IoT devices may obtain data during performance of a local AI algorithm during device operation that may be leveraged by a network-based AI algorithm to prevent or reduce susceptibility to cyberattacks.

The quantum key distribution application may include an AI algorithm to select which of the quantum IoT device are to be sent a quantum key. The AI algorithm may be based on a theoretical initial model to generate strategies for leveraging quantum computing AI to obtain a consensus on a strategy. A strategy may use a game-based algorithm to determine which IoT devices control the quantum key distribution. A strategy may use a match equilibrium algorithm to determine which IoT devices control the quantum key distribution. A strategy may use an auction-based algorithm, in which, for example, a highest bidder algorithm controls the quantum key distribution. A non-cooperative game may be used if all the IoT devices (agents) do not agree. If there is no agreement among the devices (agents), no IoT device may win, and no new network security arrangement may be reached. Non-cooperating agents may be considered “bad actors.”

A decision by quantum IoT devices in control of the quantum keys may be matrix-dependent, where the consensus may provide an outcome that is dependent on conditions, such as monetary size of a transaction to be conducted by one of the plurality of quantum IoT devices. For example, a smaller quorum of the quantum IoT devices may be allowed to win acceptance of rules that may approve one or more transactions involving a smaller sum of money, while a larger quorum of those agreeing to a decision may be needed to win acceptance of rules related to approving one or more transactions involving a larger sum of money. This decision-making strategy may prevent bad actors or persons without proper access to the IoT network from affecting a decision. Additionally, to prevent influence of bad actors, such as a user of an IoT device who has a malicious intent, the algorithm may require that each user of a quantum IoT device execute a form, such as an online form. Good actors may be provided a valid form. Bad actors may be provided with a decoy form that may be invalid. The forms may be created in real-time with generative AI.

An AI algorithm may be executed separately on one or more of the quantum IoT devices. The AI algorithm on each device may separately gather a device user's interactions with other IoTs in the network and applications on third-party applications or systems, such as an interaction with an online bank web site, accessed with the quantum IoT device. The user's interactions on a respective device may be used to train a machine learning (ML) model on the device. Data captured by the AI algorithms operating on various quantum IoT devices may be aggregated by an aggregator in the IoT network or in communication with the IoT network. The aggregated data may be used to train a network-level AI algorithm at the IoT network. The aggregated data may be used by the IoT network for applying strategic models for optimal resource distribution at the IoT network. The data obtained by the network-level AI algorithm may be anonymized by the IoT devices or at the network before it is used by the network-level AI algorithm. Anonymized portions of the collected data may be provided to the third parties to use, such as for credit scoring or finance decisions.

Illustrative embodiments of methods, systems, and apparatus in accordance with the principles of the disclosure will now be described with reference to the accompanying drawings, which form a part hereof. It is to be understood that other embodiments may be used, and structural, functional, and procedural modifications may be made without departing from the scope and spirit of the present invention.

The drawings show illustrative features of methods, systems, and apparatus in accordance with the principles of the invention. The features are illustrated in the context of selected embodiments. It will be understood that features shown in connection with one of the embodiments may be practiced in accordance with the principles of the invention along with features shown in connection with another of the embodiments.

The methods, apparatus, computer program products, and systems described herein are illustrative and may involve some or all the steps of the illustrative methods and/or some or all of the features of the illustrative system or apparatus. The steps of the methods may be performed in an order other than the order shown or described herein. Some embodiments may omit steps shown or described in connection with the illustrative methods. Some embodiments may include steps that are not shown or described in connection with the illustrative methods, but rather are shown or described in a different portion of the specification.

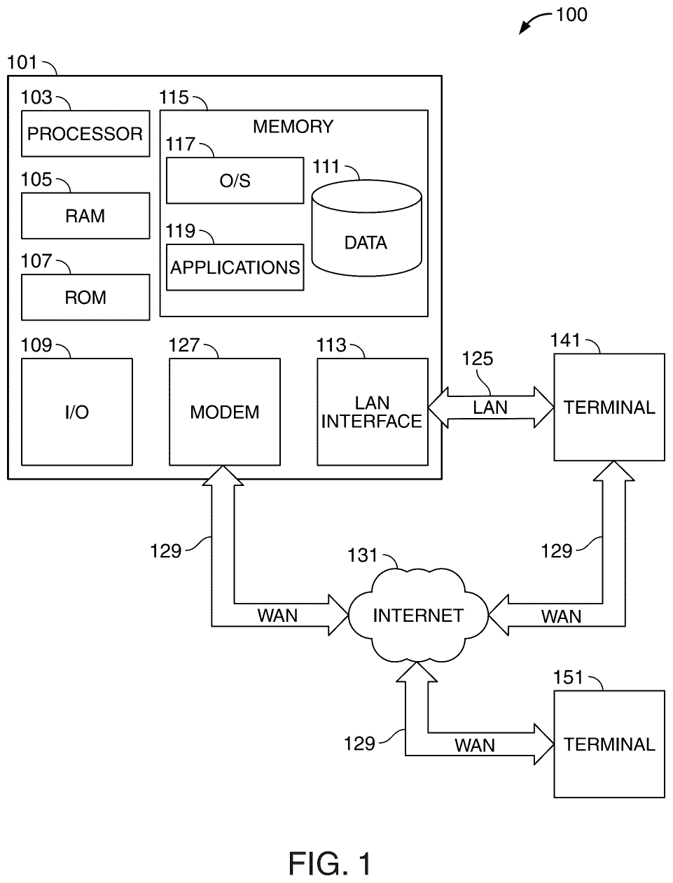

FIG. 1 shows an illustrative block diagram of system 100 that includes computer 101. Computer 101 may alternatively be referred to herein as an “engine,” a “server,” a “computing system,” or a “computing device.” Computer 101 may be a quantum computer or part of a quantum computer. Elements of system 100, including computer 101, may be used to implement various aspects of the systems and methods disclosed herein. A “user” of computer 101 may include other computer systems or servers or computing devices.

Computer 101 may have one or more “N” qubit processors as well as standard microprocessors 103 for controlling the operation of the device and its associated components, and may include RAM 105, ROM 107, input/output circuit 109, and a non-transitory or non-volatile memory 115. Machine-readable memory may be configured to store information in machine-readable data structures. The processors 103 may also execute all software running on computer 101, such as the operating system and applications. Processors 103 may establish quantum entanglement between qubits, such as entanglement between qubits in different locations. Other components commonly used for computers, such as EEPROM or Flash memory or any other suitable components, may also be part of the computer 101.

Memory 115 may be comprised of any suitable permanent storage technology—e.g., a hard drive or other non-transitory memory. Memory 115 may store software including the operating system 117 and application(s) 119 along with any data 111 needed for the operation of computer 101. Memory 115 may also store applications, videos, text, and/or audio assistance files. The data stored in Memory 115 may also be stored in cache memory, or any other suitable memory. Alternatively, some or all of computer executable instructions (alternatively referred to as “code”) may be embodied in hardware or firmware (not shown).

Memory 115 may store data as quantum states. Data may be transferred between qubits through quantum entanglement. Data may be stored on qubits as quantum states that are correlated to quantum states on other qubits. Data may be transferred between qubits through quantum entanglement.

Input/output (“I/O”) module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

Computer 101 may be connected to other systems via a local area network (LAN) interface 113. Computer 101 may operate in a networked environment supporting connections to one or more remote computers, such as terminals 141 and 151. Terminals 141 and 151 may be personal computers or servers that include many or all the elements described above relative to computer 101.

In some embodiments, computer 101 and/or Terminals 141 and 151 may be any of mobile devices that may be in electronic communication with consumer device 106 via LAN, WAN, or any other suitable short-range communication when a network connection may not be established.

When used in a LAN networking environment, computer 101 is connected to LAN 125 through a LAN interface 113 or an adapter. When used in a WAN networking environment, computer 101 may include a communications device, such as modem 127 or other means, for establishing communications over WAN 129, such as Internet 131.

In some embodiments, computer 101 may be connected to one or more other systems via a short-range communication network (not shown). In these embodiments, computer 101 may communicate with one or more other terminals 141 and 151, such as the mobile devices described herein etc., using a personal area network (PAN) such as Bluetooth®, NFC (Near Field Communication), ZigBee, or any other suitable personal area network.

It will be appreciated that the network connections shown are illustrative and other means of establishing a communications link between computers may be used. The existence of various well-known protocols such as TCP/IP, Ethernet, NFT, HTTP, and the like is presumed, and the system can be operated in a client-server configuration to permit retrieval of data from a web-based server or API (Application Programming Interface). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application programs 119 may use one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may use the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 119 may include one or more algorithms that may be used to implement features of the disclosure.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry TM, tablet, smartphone, or any other computing system for receiving, storing, transmitting, and/or displaying relevant information. Terminal 151 and/or terminal 141 may be one or more user devices. Terminals 151 and 141 may be identical to computer 101 or different. The differences may be related to hardware components and/or software components. These terminals may be other quantum computers, which may include quantum devices that use quantum processors. Quantum computers may interact with each other over a quantum network.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smartphones, multiprocessor systems, microprocessor-based systems, cloud-based systems, programmable consumer electronics, network PCs, minicomputers, mainframe computers, distributed computing environments that include any of the above systems or devices, and the like.

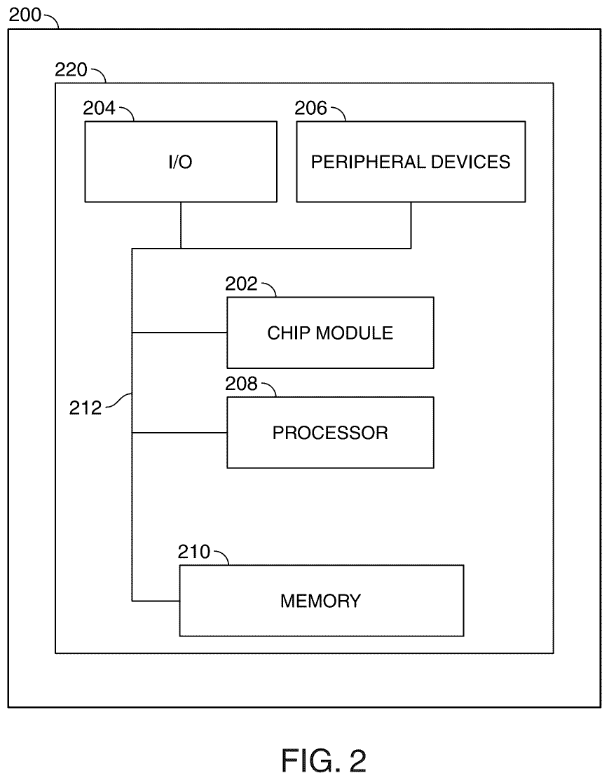

FIG. 2 shows illustrative apparatus 200, which may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY level hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

For the sake of illustration, the invention will be described as being performed by a “system.” The system may include one or more features of apparatus and methods that are described herein and/or any other suitable device or approach.

The system may include a quantum processor. A quantum processor may be used herein to refer to a computing device whose operations can harness aspects of quantum mechanics, such as superposition, interference, and entanglement.

Quantum processors are associated with vastly improved efficiencies over standard computers. Standard computers represent data in bits, which can be either 0 or 1. Quantum processors use qubits which utilize superposition (i.e., the ability to be in multiple states at the same time) to allow for a state of 0, 1, or any probability of being 0 or 1. The probabilities may be manipulated using matrix-based quantum gates, which are analogous to standard logic gates. Qubits are therefore able to represent many more data possibilities than a bit-based system of the same size. This allows for greater speed and less memory usage than standard systems.

A qubit in a state of superposition may not have a defined value because it may hold many potential values at the same time. When measured, the qubit wave function collapses to a defined state. When an entangled qubit is in a state of superposition, each of its entangled connections is also in a state of superposition. These combinations of uncertainties exponentially increase the power of quantum processors.

The quantum processor may include a default number of quantum threads. Each quantum thread may include a default number of quantum circuits. Quantum circuits may refer to hardware and software based computational models that include quantum gates and are used for executing quantum computations.

In some embodiments, at least one of the quantum circuits may include a Toffoli gate. A feature of the Toffoli gate is its universal nature, meaning the structure is able to represent standard operations as well as quantum operations. In some embodiments, at least one of the quantum circuits may include a Hadamard gate. A feature of the Hadamard gate is the ability to represent a superposition state.

Quantum computing may be referred to as the use of quantum-mechanical phenomena such as superposition and entanglement to perform computations. The smallest bit in a quantum computing system may be called a qubit.

Executable instructions may be executed by an “N” qubit processor on a computer system. “N”may be a number between two and ten thousand.

The amount of data that a quantum computing system may be able to hold and manipulate may grow exponentially with the number of qubits included in the quantum computing system's processing core. A quantum computing system with “N” qubits may be able to simultaneously represent 2N states. Therefore, two qubits may hold four states, three qubits may hold eight states, fifty qubits may hold 1,125,899,906,842,624 states, and 10,000 qubits may hold 210000 states.

Other standard components of a computer system may be present, such as communication links, displays, input and output devices, read-only and random-access memory, and other components.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

The non-transitory memory may be configured to store executable data configured to run on the “N”-qubit processor and/or a standard processor.

The “N” qubit processor or standard processors may control the operation of the computer system and its components, which may include RAM, ROM, an input/output module, and other memory.

Other components commonly used for computers, such as EEPROM or Flash memory or any other suitable components, may also be part of the apparatus and computer system.

A communication link may enable communication with other computers and servers, as well as enable the program to communicate with databases. The communication link may include any necessary hardware (e.g., antennae) and software to control the link. Any appropriate communication link may be used, such as Wi-Fi, Bluetooth, LAN, and cellular links. Multiple communication links may be present. In some embodiments, the network used to communicate may be the Internet. In some embodiments, the network may be an internal intranet or other internal network.

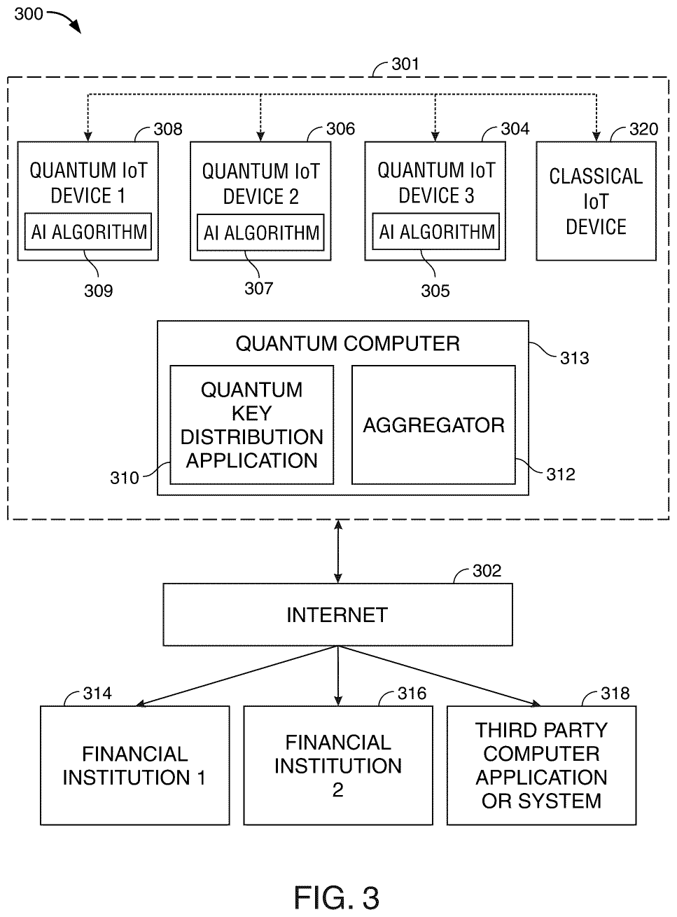

FIG. 3 shows an illustrative system architecture 300 for a system that includes a network 301 of quantum IoT devices 304, 306, 308 that may communicate over the Internet 302 with third-party computer applications or systems that are operated by parties not associated with one or more of the quantum IoT devices in quantum IoT network 301. The third-party may be, for example, a financial institution, such as financial institution 1 314 or financial institution 2 316. The third-party computer application or system may include, for example, an online banking application for banking at a financial institution. The third-party computer application or system may be some other application, such as an application that is available via a web site 318 of a third-party.

Some or all of quantum IoT devices 304, 306, 308 in network 301 may be heterogenous so that quantum IoT devices 304, 306, 308 may or may not use different technologies, such as different operating systems or protocols. Each of quantum IoT devices 304, 306, 308 may operate a separate AI algorithm 305, 307, 309 which may initially be the same. However, the AI algorithm on each quantum IoT device may evolve to differ based on operations performed using a quantum IoT device that may train an ML model used with the AI algorithm to be updated. Network 301 may also include one or more classical IoT devices, such as classical IoT device 320 that uses a classical processor.

AI algorithms 305, 307, 309 on the quantum IoT devices may gather data regarding a quantum IoT device's interactions with other IoTs in the network and applications on third-party networks, such as an interaction with an online financial website, accessed with the respective quantum IoT devices. The user's interactions on a respective device may be used to train a machine learning (ML) model on the device. Data captured by the algorithms 305, 307, 309 operating on various quantum IoT devices may be aggregated by an aggregator 312 in quantum IoT network 301 or in communication with IoT network 301. Aggregator 312 in quantum IoT network 301 may be resident on quantum computer 313. The aggregated data may only capture data that does not identify a quantum IoT device or a user of that device to protect privacy of the users. The aggregated data may be used to train an AI algorithm at the IoT network.

Quantum computer 313 may interact with quantum IoT devices 304, 306, 308 and may include a quantum key distribution application 310 that may be in communication with quantum IoT devices 304, 306, 308. Quantum key distribution application 310 may be located within network 301 of quantum IoT devices 304, 306, 308 or may be located outside of network 301, but in communication therewith to distribute quantum keys to quantum IoT devices 304, 306, 308. As described above, the possession of a quantum key by one or more of the quantum IoT device may assist with algorithms that are performed using quantum IoT devices 304, 306, 308.

For example, when quantum IoT device 304 possesses a quantum key, the quantum key may enable quantum IoT device 304 work with other IoT devices as a consortium to make governance decisions for the network of IoT devices by enabling communications between the quantum IoT devices in the network. Governance decisions may include determining security rules for the network of quantum IoT devices for managing interactions between the quantum IoT devices and a third-party network to prevent or mitigate cyberattacks on the quantum IoT devices. The security rules may be adopted when a consensus of the quantum IoT devices about the security rules is obtained. The quantum key may be sent to all the quantum IoT devices in network 301 or may be sent to only a subset of the quantum IoT devices in the network, such as quantum IoT devices 304 and 306.

Security rules may relate to different aspects of IoT devices 304, 306 and 308 being allowed to conduct interactions or certain types of interactions with third-party applications. For example, security rules may relate to a type of transaction that is allowed, such as a banking transaction with a particular financial institution, performing searches on certain websites that may be found to be safe based on experience by one or more the quantum IoT devices, or blocking access to certain third-party applications or systems. A copy of the security rules, as revised from time to time, may be provided to the IoT devices.

The governing rules of network 301 may specify that a consensus on the selection of security rules be achieved by a majority vote by the quantum IoT devices in network 301. The governing rules may specify that the consensus requires unanimity. The security rules may be updated on an ongoing basis.

Quantum key distribution application 310 may include its own AI algorithm to select which of the quantum IoT device are to be sent a quantum key. The AI algorithm of quantum key distribution application 310 may be based on a theoretical initial model to generate strategies for leveraging quantum computing AI to obtain a consensus on a strategy.

A strategy may use a game-based algorithm to determine which quantum IoT devices control the quantum key distribution. A strategy may use a match equilibrium algorithm to determine which IoT devices control the quantum key distribution. A strategy for an auction-based algorithm, in which, for example, a highest bidder algorithm controls the quantum key distribution.

For a game-based algorithm, a non-cooperative game may be used if all the quantum IoT devices (agents) do not agree. If there is no agreement among the devices (agents), no quantum IoT device may win and no new network security arrangement may be reached and no one may win. Non-cooperating agents may be considered “bad actors.”

A decision by network 301 on whether a type of interaction or transaction may be performed may be matrix-dependent such that the consensus may depend on multiple conditions. For example, a consensus by a smaller quorum of those agreeing to a decision may be sufficient for accepting rules related to approving a transaction involving a smaller sum of money, while a larger quorum of those agreeing to a decision may win for accepting rules related to approving a transaction involving a larger sum of money.

A decision-making strategy may prevent bad actors or persons without proper access to the IoT network from affecting a decision. Additionally, to prevent influence of bad actors, the AI algorithm at quantum key distribution application 310 may require that each user of a quantum IoT device execute a form. Good actors, such as those quantum IoT devices that are cooperative, may be provided with a valid form for a user of the device to complete, while a bad actors may be provided with a decoy form that may be invalid. The forms may be created in real-time with generative AI.

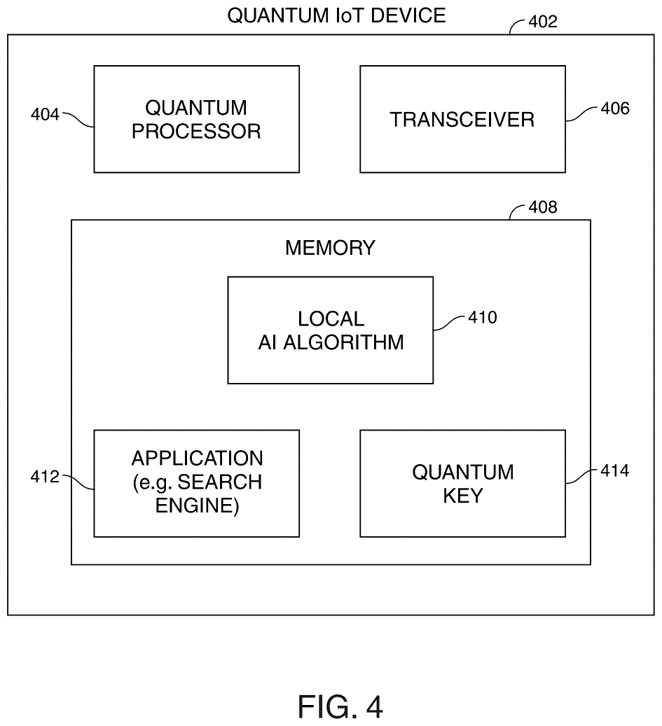

FIG. 4 shows an illustrative architecture of a quantum IoT device 402 (such as quantum IoT devices 304, 306, 308) that may be used in accordance with principles of the disclosure. Quantum IoT device 402 may include quantum processor 404, transceiver 406 for communicating with other quantum IoT devices in a network and for communicating with systems outside of the network, and a memory 408. Memory may store an IoT device-specific local AI algorithm 410, and a local application 412, such as a search engine, for interacting with a third-party computer application via the Internet. An example of a third-party computer application may be a banking application. Memory 408 at quantum IoT device 402 may further include a quantum key 414 that may be distributed to quantum IoT device 402 by a quantum key distribution application. Memory 408 may be a quantum medium in which data may be stored as quantum-entangled bits.

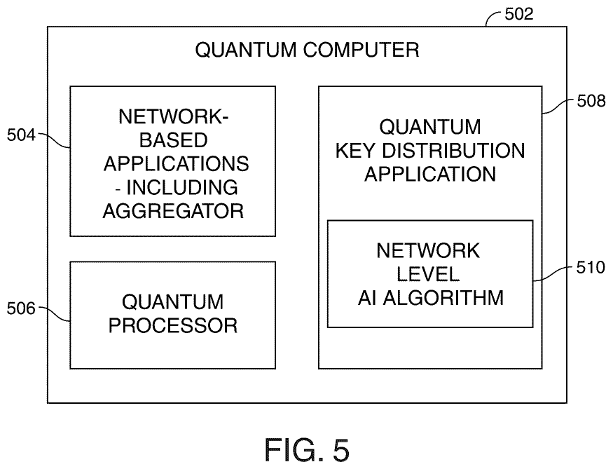

FIG. 5 shows an illustrative architecture of a quantum computer 502 (such as quantum computer 313) that may be included within a network that includes quantum IoT devices. Quantum computer 502 may include one or more network-based applications 504, that may operate within the network of quantum IoT devices. Network-based applications 504 may include an aggregator for aggregating data obtained from individual quantum IoT devices, such as data compiled by quantum IoT devices by the local AI algorithm. Quantum computer 502 may further include a quantum processor 506, a quantum key distribution application 508 that may include a network level AI-algorithm 510.

Network-based applications 504 may include a fraud alert application or system that is configured to propagate a fraud alert message from one quantum IoT device that has detected fraud to other quantum IoT devices in the network of IoT devices.

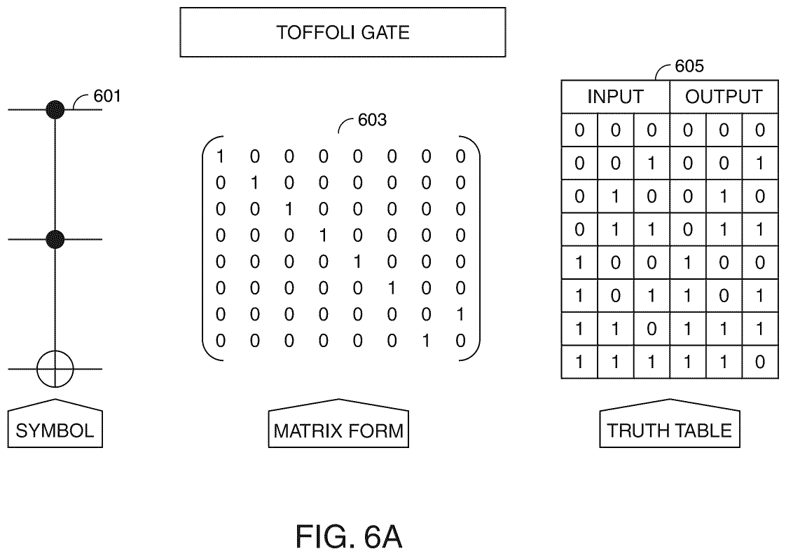

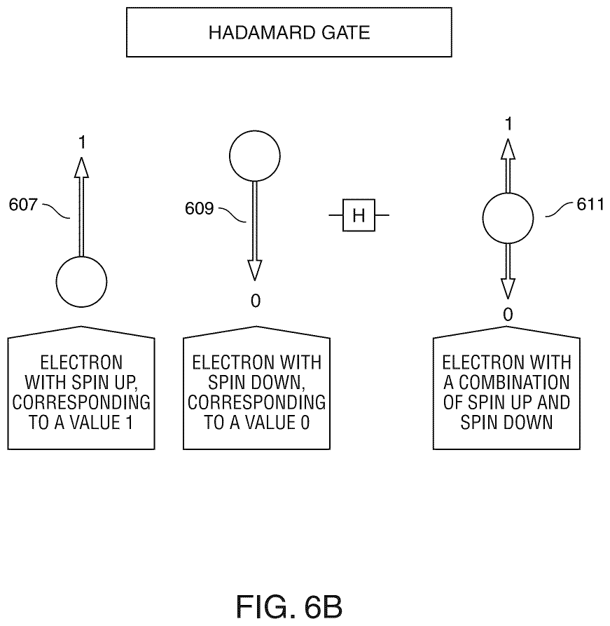

FIGS. 6A and 6B show illustrative diagrams of exemplary quantum gates in accordance with principles of the disclosure.

FIG. 6A shows symbol 601, matrix form 603, and truth table 605 of a Toffoli gate. A Toffoli gate is a universal reversible logic gate, which means that it enables simulation of any standard reversible circuit. In operation, as seen in truth table 605, the Toffoli gate has a 3-bit input and 3-bit outputs. The first two output bits always mirror the first two input bits. The third bit also stays the same unless the first two input bits are both set to 1—in which case the third output bit is inverted from the third input bit. The Toffoli gate is therefore also known as the “controlled-controlled-not” gate.

FIG. 6B shows representations of a Hadamard gate. Symbol 607 shows a representation of electron spin up, which corresponds to the value 1. Symbol 609 shows a representation of electron spin down, which corresponds to the value 0. Symbol 611 shows a representation of electron spin up and down, which corresponds to the value that represents a superposition of 1 and 0.

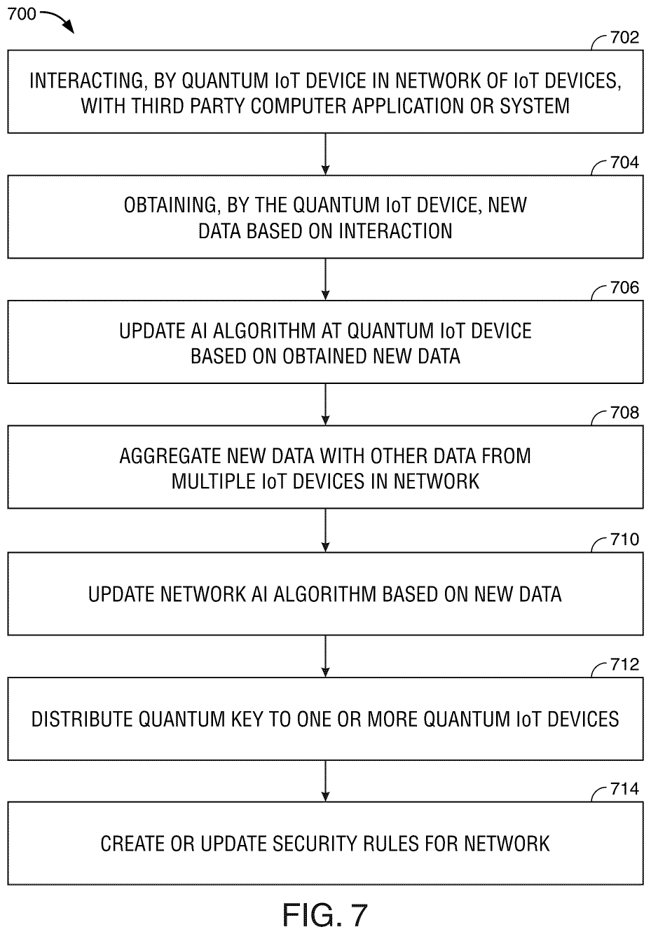

FIG. 7 shows an illustrative embodiment of a flow chart 700 for leveraging quantum computing AI to prevent or mitigate cyberattacks on a network of IoT devices. The network may include quantum IoT devices that may use AI and may include classical IoT devices. The IoT devices or the network may include an initial set of security rules. At step 702, a respective quantum IoT device in the network may interact with a third-party computer application or system. The third-party application may be, for example, a banking application that is accessible via the Internet. At step 704, data from that interaction may be obtained at the respective quantum IoT device. At step 706, the obtained data may be used to train an AI algorithm that may be operating locally at the respective quantum IoT device. Each of the quantum IoT devices in the network may be performing steps 702 to 706 separately.

At step 708, the data that is obtained by each quantum IoT device based on interactions with third-party computer applications or systems may be aggregated. At step 710, the aggregated data may be used to update a network-wide AI algorithm such that the security rules for the network may be created or updated based on data from a consortium of the quantum IoT devices in the network that use AI. At step 712, a copy of a quantum key may be distributed to one or more of the quantum IoT devices. Each of the quantum IoT devices that receive a copy of the quantum key may participate in the creation or updating of security rules for the network.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Thus, methods, apparatus, and systems for leveraging quantum computing artificial intelligence to prevent or mitigate cyberattacks on quantum IoT devices may be provided. Persons skilled in the art will appreciate that the present invention can be practiced by other than the described embodiments, which are presented for purposes of illustration rather than of limitation.

What is claimed is:

1. A system comprising:
a network comprising a plurality of quantum Internet of Things (IoT) devices, wherein each of the plurality of quantum IoT devices comprises a respective quantum processor; and
a quantum key distribution application that is configured to distribute a quantum key to one or more of the plurality of quantum IoT devices;
wherein the quantum key distribution application comprises an AI algorithm that is configured to enable each of the plurality of quantum IoT devices to select one or more of the plurality of quantum IoT devices to which to distribute one or more copies of the quantum key; and
wherein receipt of one of the one or more copies of the quantum key by a respective one of the plurality of quantum IoT devices enables the respective quantum IoT device to participate in determining security rules for managing interactions or transactions between the plurality of quantum IoT devices and a third-party computer application or system, the security rules mitigating cyberattacks on the plurality of quantum IoT devices.

2. The system of claim 1, wherein the plurality of quantum IoT devices comprises heterogeneous quantum IoT devices that use different operating systems or protocols.

3. The system of claim 1, wherein the AI algorithm is further configured to generate a consensus among the plurality of quantum IoT devices that receive one of the one or more copies of the quantum key as to which of the plurality of quantum IoT devices controls future distribution of the quantum key.

4. The system of claim 3, wherein the AI algorithm is configured to generate the consensus using a game-based algorithm.

5. The system of claim 1, wherein the AI algorithm is trained based on previous decisions made by the plurality of quantum IoT devices.

6. The system of claim 1, wherein the security rules are configured to be dependent on a monetary size of a transaction to be conducted by one of the plurality of quantum IoT devices.

7. The system of claim 1, wherein the AI algorithm requires a predetermined quorum of the plurality of quantum IoT devices to agree to the security rules.

8. The system of claim 1, wherein the AI algorithm is configured to optimize resource distribution for the plurality of quantum IoT devices.

9. The system of claim 1, wherein the quantum key distribution application is configured to require completion of a form by each quantum IoT device to participate in a determination of the security rules.

10. The system of claim 9 wherein, upon detection by the AI algorithm of attempted fraud by one of the plurality of quantum IoT devices, the AI algorithm is configured to provide to the respective quantum IoT device at which the attempted fraud is detected a decoy form that, despite execution, does not allow access to the quantum key by the respective quantum IoT device at which the attempted fraud is detected.

11. The system of claim 10, wherein the AI algorithm comprises a generative AI algorithm that is configured to generate the decoy form in real time.

12. The system of claim 1, wherein the network comprises a fraud alert system that is configured to propagate a fraud alert message from one of the plurality of quantum IoT devices that has detected fraud to others of the plurality of quantum IoT devices in the network.

13. The system of claim 1, wherein the network comprises an aggregator for aggregating data collected from the plurality of quantum IoT devices.

14. The system of claim 1, wherein the third-party computer application or system comprises a banking network accessed by one or more of the plurality of quantum IoT devices.

15. The system of claim 1, wherein the plurality of quantum IoT devices further comprise a classical IoT device comprising a classical processor.

16. A system comprising:
a network comprising a plurality of quantum Internet of Things (IoT) devices;
wherein:
each of two or more of the plurality of quantum IoT devices comprises:
a quantum processor;
an application that is operable, using the quantum processor, to provide electronic access from a respective one of the plurality of quantum IoT devices to one or more third-party computer applications or systems operated by a third party; and
a first artificial intelligence (AI) algorithm that is trained, using the quantum processor, based on data derived from user interactions between the respective quantum IoT device and the one or more third-party computer applications or systems; and
an aggregator, comprising a processor, that is operable to aggregate data derived from the user interactions with the one or more third-party computer applications or systems and the plurality of quantum IoT devices and to provide the aggregated data to a second AI algorithm at the one or more computer applications or systems in the network to be used to train the second AI algorithm to prevent or mitigate cyberattacks on the plurality of quantum IoT devices.

17. The system of claim 16, wherein the third party is a financial institution.

18. The system of claim 16, wherein the aggregator is configured to anonymize the aggregated data so that the aggregated data does not identify a user of a respective one of the plurality of quantum IoT devices from which the aggregated data has been obtained.

19. The system of claim 16, wherein the aggregator is further configured to train one or more ML models of the second AI algorithm.

20. The system of claim 16, further comprising:
a quantum key distribution application that is configured to operate across the plurality of quantum IoT devices;
wherein the quantum key distribution application comprises a third AI algorithm that is configured to select one or more of the plurality of quantum IoT devices to which to distribute a copy of a quantum key across the plurality of quantum IoT devices; and
wherein possession of the quantum key by a respective one of the plurality of quantum IoT devices enables the respective ones of the plurality of quantum IoT devices to which the copies of the quantum key are distributed to determine security rules for managing interactions between the plurality of quantum IoT devices and a respective third-party computer application or system or a third-party network to prevent or mitigate the cyberattacks on the plurality of quantum IoT devices.
